(19) United States
(12) Patent Application Publication
(10) Pub. No.: US 2006/0085318 A1
(43) Pub. Date: Apr. 20, 2006

(54) Systems and methods for providing reverse-auction

(76) Inventor: Kevin Cohoon, Aurora, IL (US)

Correspondence Address: TRAN & ASSOCIATES, 6768 MEADOW VISTA CT., SAN JOSE, CA, 95135, US

(21) Appl. No.: 10/966,386

(22) Filed: Oct. 15, 2004

(51) Int. Cl. G06Q 40/00

(52) U.S. Cl. 705/37

(57) ABSTRACT

Systems and methods are disclosed for conducting a reverse auction by receiving request data for a requested item, the request data including an item description and bid evaluation information including at least desired price and proximity to a predetermined location; storing the request data in a requisition database; receiving bid data generated in response to the request data, the bid data including bid item information generated in response to the item description of the requested item and bid evaluation information; storing the bid data in a bid database; and determining at least one winning bid at auction close based the bid data matching desired price and proximity.

### COPYRIGHT RIGHTS

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

The present invention relates to a computerized reverse auction system.

Reverse auctions have traditionally taken the form of the distribution of documents such as a Request for Information, Request for Quotation, Request for Proposal, and/or a Specification to entities that may have an interest in bidding to provide goods and services at a competitive price. In contrast with the typical “forward” auction, the dimensions for selecting a winning bidder are typically not just best price, but include a variety of additional dimensions, such as the brand and quality of the merchandise proposed, the timeliness of delivery, and the quality of service. Furthermore, what is apparently the best offer may not be the eventual winning bid. Further, the requestor of goods and services may elect to select two or more of the top bidders with whom to enter a negotiation. Thus, the winning bidder at the completion of the auction may not be the eventual winner of the business contract, although there are circumstances in which the winning bidder will be the winner of the contract. Finally, while the traditional forward auction has a centralized local point of control through which all initiatives are sourced, the reverse auction may have multiple local and remote sources from which all requests are initiated.

As noted in U.S. Pat. No. 6,647,373 to Carlton-Foss, traditional reverse auctions based on paper media require that formal documents be distributed on paper to prospective bidders, and that those bidders be found and identified for a period long enough prior to the close of the bidding process so that they are able to submit their bids. When a modification is made to a request, an entire round of communications is required with paper and voice to inform the bidders of the changes. The administrative overhead for setting up and carrying out a “bid” is so great that only complex, “big ticket” goods and services can reasonably be requisitioned using this method.

Since the late 1990's, the Internet has profoundly changed business realities, providing many different auction sites that have been seller and buyer driven. A noteworthy example of a buyer-driven electronic commerce system is that operated by PriceLine.com and described in U.S. Pat. No. 5,794,207 issued to Walker et al. In this system many buyers compete for airline tickets by submitting a bid for an airline ticket on the PriceLine website, and airlines can choose to accept a bid, thereby committing the buyer to buy the ticket. This buyer-driven model allows for the seller to agree with the buyer's terms.

Another example of a buyer-driven electronic commerce system is that operated by Ubid.com and described in U.S. Pat. No. 6,266,652 issued to Godin et al. In this system “the method comprises maintaining a computer database of product information, identifying different products to be auctioned, assigning to each product a designated time for the product to be auctioned, promoting the product and the designated time of the auction prior to the auction to increase awareness of the product, carrying out an auction at the designated time by setting a fixed time period for completing the auction, displaying a current price for the product and decreasing the price of the product as the time remaining in the auction decreases, displaying the quantity of the product remaining to be auctioned and decreasing the quantity to reflect, during-the auction process, instructions from purchasers of their desire to purchase the product as the instructions are received thereby providing dynamic feedback to potential purchasers during the auction, providing each potential purchaser with a designated actuation control for instructing the computer site of the decision to purchase the product at the current price at the time of receiving the instructions and registering potential purchasers and obtaining and recording financial data for automated payment of a purchased product”. This auction system benefits the buyer with low prices of established database merchandise.

Even though the above systems are improvements over previous reverse auction techniques, a need exists for a computerized buyer-driven reverse auction system that allows buyers to be connected with qualified vendors to obtain the lowest possible price.

### SUMMARY

Advantages of the system may include one or more of the following. The system provides a buyer-driven reverse auction system of commerce that allows buyers to be connected with qualified vendors to obtain the lowest possible price. The system allows buyers to use a reverse auction apparatus in which they can enter products or services they want to purchase locally or globally and let the vendors compete against one another for the lowest possible price in real time for a defined period to win a binding purchase agreement. Buyers of this system can obtain more control over their terms and conditions, including location of product pickup, while initiating vendors to compete for their business. For example, an individual seeking a dishwasher generally would not want to contact every single appliance shop in their area or globally and communicate details of his needs to each. The buyer's benefits from doing so (e.g., achieving a lower price) would be vastly outweighed by the amount of time and money expended in the effort. This reverse auction system would not only allow the buyer the ability to communicate the details of their purchase once, but the ability to locate the item for pickup. This will allow the buyer to purchase items that might not have been purchased with the systems described as above due to the expense of shipping, insurance, and complications with warranties.

Using the system, buyers can locate bidding vendors in their local area in which they could receive their products or services within a matter of minutes from their locations. For example, buyers can bid for an apartment rental or a haircut and receive their services in a specified location. Such precision minimizes the number of offers for incorrect items or for correct items offered by unqualified sellers or providers. Another advantage is that the buyers do not need to reveal telephone numbers or email information in order to allow sellers to reach them. Thus, buyers avoid receiving many intrusive and unwanted telephone calls or emails from sellers.

Another advantage of this system is that it allows both small companies and large companies equal opportunities. This system is advantageous for smaller companies, because buyers will be looking to purchase items locally, creating a network of unlimited potential customers. With the traditional systems, only large companies would compete for the buyers business more so than smaller companies, due to the ability for the larger company to reduce prices because of bulk buying. Now that buyers can shop locally, smaller companies will be able to bid for buyers due to the conveyance for vendors and buyers.

A further advantage of the system is achieved by providing buyers and vendors complete privacy of personal information that is revealed on the reverse auction system. Traditional systems allow potential buyers to post descriptions of products and services they desire on a Web site, along with any personal information that may better qualify their wants to the sellers. The responses from sellers include information identifying the seller. This system eliminates any personal information to both the buyer and the vendor and only show a personal identification code without revealing location, phone numbers, email addresses, or even names to better qualify either the buyer or vendor.

Yet another advantage of the system is that it allows qualified vendors already established in the system to find buyers with little effort and costs. The vendors no longer will need to pay for advertisements, make cold calls, or even spend extra money on their location of business. This system will bring the buyers to the vendor and allow the vendor to determine how much or little of a profit they want to make on certain products or services. This will ultimately allow the buyer to find qualified local or global vendors with no cost from the conveyance of the Web or telephone.

Another advantage of the inventive system is that it keeps the buyer from receiving large numbers of unwanted offers from unqualified sellers. This system will only notify the qualified vendors for the buyers wanted product or service within a defined geographical area or globally. If the buyer notifies the reverse auction system to only find vendors within a certain radius, the system will only allow those vendors to bid. Also, due to the monetary barrier imposed by the buyer's maximum price willing to pay for the product or service, unqualified vendors would only lose time and money to respond to the buyer if they cannot price at or below the buyer. This system is more advantageous than the pervious ones established because those systems filter unqualified sellers out by only monetary means while listing buyers wants globally to all potential sellers and not limited to a few select.

A further advantage is that the buyer only needs to explain the wanted product or service once to vendors. For example, a buyer looking to rent an apartment would only need to specify the area of the wanted apartment, how many bedrooms, if they have certain amenities such as a pool, if parking was included, and the length of their lease only once to the system. The reverse auction will forward this information only to the qualified vendors within all these categories and open biding to those who can match or beat the buyers wanted price. Traditional systems allow this reverse auction bidding, but only on products in which are already established on their Web Site. This invention allows the buyer to receive bids on products or services beyond what is on the site, leaving the control with the buyer in what is defined as a true buyer-driven system.

Yet another advantage of the system is that once the buyer and vendor exchange business, the buyer and vendor would be at a disadvantage to freely communicate with one another about future business. The buyer would be at a disadvantage to communicate with the vendor because they may find the same product or service with another vendor at a more reasonable price the next time they used the system. The vendor is at a disadvantage to freely communicate with the buyer, because they may receive a better price for their product or service the next time they bid on the system. This feature of the invention only adds to maintaining anonymity between the buyer and vendor. Traditional systems allow the buyers and sellers to freely communicate outside of the system after a business transaction. However, this leaves the buyer and the seller without control of their own privacy.

Another advantage of this system is that it will contain a running database of all business transactions such as products sold and for what price. This database then can be used by local businesses, small or large, to objectively exam the highest selling products and for what price range the products sold for in a specific geographic area. This can help business owners determine if they are competitive in their area, help business entrepreneurs determine if their business could succeed in such an area, and ultimately lead to lower prices for customers through competition.

The system allows a consumer to relate all of the steps of a reverse auction transaction to each other and to save all of the information regarding each of the various steps in one convenient and easily accessible location. The system is also efficient and low in operating cost. It also is highly responsive to user demands.

Other advantages and features will become apparent from the following description, including the drawings and claims.

### BRIEF DESCRIPTION OF THE DRAWINGS

FIGS. 1-4 show different embodiments that provide a timed buyer-driven reverse auction system.

### DESCRIPTION

Referring now to the drawings in greater detail, there is illustrated therein structure diagrams for a reverse auction transaction system and logic flow diagrams for the processes a computer system will utilize to complete various auction transactions. It will be understood that the program is run on a computer that is capable of communication with consumers via a network, as will be more readily understood from a study of the diagrams.

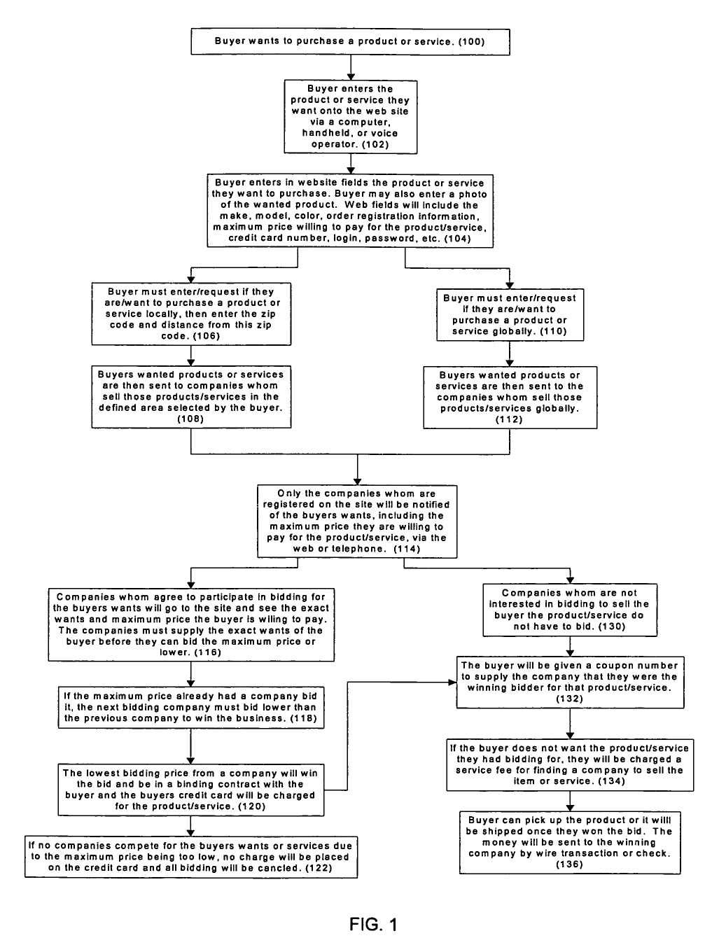

FIGS. 1-3 show three different embodiments that provide a timed buyer-driven reverse auction system that will inexpensively connect buyers of products and services to vendors locally (e.g., within a specified radius determined by the buyer) and globally through the use of computer terminals or voice telephony. The buyer will construct a detail description of the products (e.g., make, model numbers, color and pictures) or services wanted, including their maximum price willing to pay, and submit them via the Internet or voice telephony to the appropriate area within the reverse auction system. The vendors listed only for selling those products or services locally or globally will be notified that a buyer has established a time completion for all vendors bidding. The vendor will be notified of the entire buyer's terms (e.g., warranty, maximum price, shipping or pickup, etc.) while keeping anonymity. If the vendor accepts all the terms set forth by the buyer, they have the option to place a bid lower or equal to the maximum price set by the buyer or they can forgo the auction. The vendor must summit the same terms as the buyer and may supply descriptive analyses of the product to the buyer (i.e., make, model, color and even a picture). If the buyer sets the maximum price willing to pay too low for vendors, then no vendors will place bids on the products or services and time will elapse without bidding. If a vendor bids on a product or service, their bid will be placed into the reverse auction system for buyers and vendors to see. This will allow all appropriate vendors the ability to decide if they can sell a product or service cheaper than the first vendor. The system will decrease the next bid incrementally as new vendors place a bid. If so, the lowest bid will be placed on the Web site in front of the first bid while notifying the first vendor of the changes. If the original vendor can go lower than the second vendor, the first vendor may modify their bid lower to beat out other vendors. This will continue until the end time is reached in which the lowest bidding vendor is bound to a legal contract with the buyer.

FIG. 1 illustrates a first exemplary process where a buyer wants to purchase a product or service (100). In this process, the buyer enters the product or service he or she wants onto the web site via a computer, handheld device, or voice operator (102). The buyer enters data into one or more website fields the product or service that he/she wants to purchase. The buyer may also enter a photo of the wanted product. In one embodiment, the web fields include the make, model, color, order registration information, maximum price willing to pay for the product/service, credit card number, login, password, among others (104). Next, the buyer enters/requests if he wants to purchase a product or service locally. The buyer then enters a zip code and distance from this zip code (106). The buyer can also designate if he/she wants to purchase a product or service globally (110).

The buyer's wanted products or services are then sent to companies whom sell those products/services in the defined area selected by the buyer (108). The buyer's wanted products or services are then sent to one or more companies that sell those products or services globally (112).

Next, companies that are registered on the site are notified of the buyer's request(s), including the maximum price the buyer is willing to pay for the product/service, via the web or telephone (114). Companies that agree to participate in bidding for the buyers wants can access the site and see the requested items/services and maximum price the buyer is wiling to pay. The companies should be able to supply the exact wants of the buyer before they can bid the maximum price or less (116). If the maximum price already had a bid, the next bidding company must bid lower than the previous company to win the business (118). The lowest bidding price will win the bid and the price and deliverable are distilled into a binding contract with the buyer and the buyers credit card will be charged for the product/service (120). If no companies compete for the buyers wants or services due to the maximum price being too low, no charge will be placed on the credit card and all bidding will be canceled (122).

Companies that are not interested in bidding to sell the buyer the product/service do not have to bid (130). The buyer will be given a coupon number to supply the company that they were the winning bidder for that product/service (132). If the buyer does not want the product/service they had bidding for, they will be charged a service fee for finding a company to sell the item or service (134). Buyer can pick up the product or it will be shipped once they won the bid. The money will be sent to the winning company by wire transaction or check. (136)

The system of FIG. 1 supports a timed reversed auction capability. The system can efficiently and inexpensively connect competing vendors' to individual buyers. The system of FIG. 1 allows potential buyers of goods and services to communicate with established vendors' via the Internet. This buyer-driven system allows prospective buyers to conveniently search for a binding purchase agreements based on their purchase offer globally or locally with vendors' through a Web site or conventional communications systems such as voice telephony. Vendors' of those products and services will be notified via email or voice telephony in which they can access the descriptions posted by the buyers and selectively bid responses (i.e., vendor's agreements to the buyers terms with bids lower than or equal to the buyers wanted price, thus binding the buyer to the lowest priced vendor to a contract). The apparatus will post all vendors' bids, while keeping anonymity, to allow all interested vendors' the possibility to bid lower.

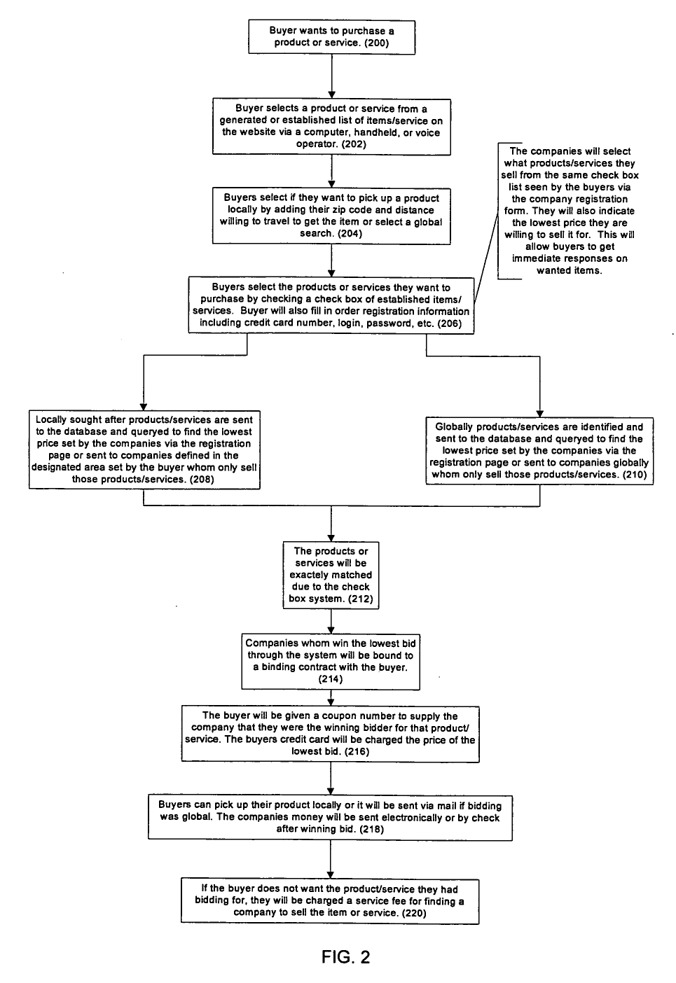

FIG. 2 illustrates a second exemplary process where one or more buyers are interested in purchasing a product or service (200). The buyers select product(s) or service(s) from a generated or established list of items/services on the website via a computer, handheld device, or voice operator (202). The buyers select if they want to pick up a product locally by adding their zip code and distance that the buyers are willing to travel to get the item or select a global search (204). The buyers select the products or services they want to purchase by checking a check box of established items/services. The buyers also fill in order registration information including credit card number, login, password, etc. (206). The companies will select what products/services they sell from the same check box list seen by the buyers via the company registration form. They will also indicate the lowest price they are willing to sell it for. This will allow buyers to get immediate responses on wanted items.

Locally sought-after products or services are searched in a database to find the lowest price set by the companies via the registration page. Alternatively, locally sought items may be sent to companies defined in the designated area set by the buyer that only sell those products/services (208).

Globally sought-after products/services are searched in a database to find the lowest price set by the companies via the registration page or sent to companies globally selling the desired products/services (210). The products or services will be matched due to the check box system (212). Companies whom win the lowest bid through the system will be bound to a binding contract with the buyer (214). The buyer will be given a coupon number to supply the company that they were the winning bidder for that product/service. The buyers credit card will be charged the price of the lowest bid. (216)

Buyers can pick up their product locally or it will be sent via mail if the bidding was global. The companies money will be sent electronically or by check after winning bid (218). If the buyer does not want the product/service they had bidding for, they will be charged a service fee for finding a company to sell the item or service (220).

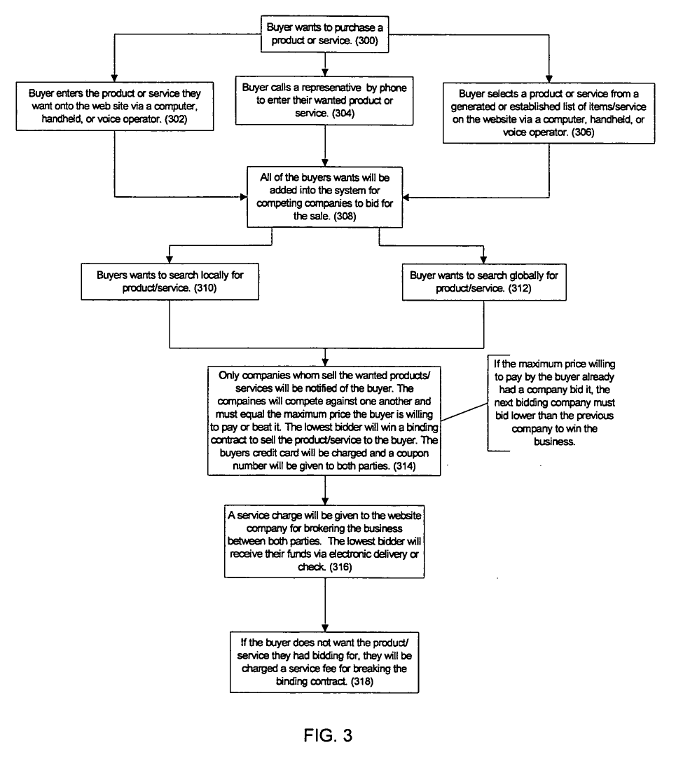

FIG. 3 illustrates a third exemplary process where a buyer wants to purchase a product or service (300). Buyer enters the product or service they want onto the web site via a computer, handheld, or voice operator (302).

In one case, buyer calls a representative by phone to enter their wanted product or service (304). The buyers can call the representative using conventional telephony or can call the website via voice-over-Internet protocol (VOIP). Also, the database can be voice activated with IP and people can enter desired products/services from a check list of items established in the system. For example, if one wanted to buy software from the website, one would be able to call via voice-over-IP and go through a voice operated system to order and receive bidding on the product and get immediate price and location to buy the product. The VoIP systems extend phone and feature portability to remote locations. Extending voice, data and information systems through the enterprise to remote call centers, business offices, and even home offices provide many advantages. For example, enabling agents to work from remote offices or home saves substantial dollars in terms of call center space and facility services. It also provides access to skilled personnel across diverse geographic areas and time zones and enhances flexible scheduling. Calls to customer interaction facilities are more scalable and easily routed to alternate call centers, local offices, or agents working from home. Routing can be based on call volumes, skills, language, call queues, and time zones. In one embodiment, the VOIP systems can integrate Web and voice functionality, known as “click-and-talk”. Current and potential customers browsing Web pages can initiate live interaction sessions and obtain additional information by simply clicking on an object and talking directly with a call center agent. This “click-and-talk” capability can significantly increase the efficiency and effectiveness of an agent's interaction with customers.

All of the buyers wants will be added into the system for competing companies to bid for the sale (308). Buyer selects a product or service from a generated or established list of items/service on the website via a computer, handheld, or voice operator (306). Buyers wants to search locally for product/service (310). Buyer wants to search globally for product/service (312). Only companies whom sell the wanted products/services will be notified of the buyer. The companies will compete against one another and must equal the maximum price the buyer is willing to pay or beat it. The lowest bidder will win a binding contract to sell the product/service to the buyer. The buyer's credit card will be charged and a coupon number will be given to both parties (314).

A service charge will be given-to the website company for brokering the business between the parties. The lowest bidder will receive their funds via electronic delivery or check (316). If the buyer does not want the product/service they had bidding for, they will be charged a service fee for breaking the binding contract (318). If the maximum price willing to pay by the buyer already had a company bid it, the next bidding company must bid lower than the previous company to win the business.

The embodiments of FIGS. 1-3 allow buyers to use a reverse auction apparatus in which they can enter products or services they want to purchase locally or globally and let the vendors compete against one another for the lowest possible price in real time for a defined period to win a binding purchase agreement. Buyers of this system can obtain more control over their terms and conditions, including location of product pickup, while initiating vendors to compete for their business. For example, an individual seeking a dishwasher generally would not want to contact every single appliance shop in their area or globally and communicate details of his needs to each. The buyer's benefits from doing so (e.g., achieving a lower price) would be vastly outweighed by the amount of time and money expended in the effort. This reverse auction system would not only allow the buyer the ability to communicate the details of their purchase once, but the ability to locate the item for pickup. This will allow the buyer to purchase items that might not have been purchased with the systems described as above due to the expense of shipping, insurance, and complications with warranties.

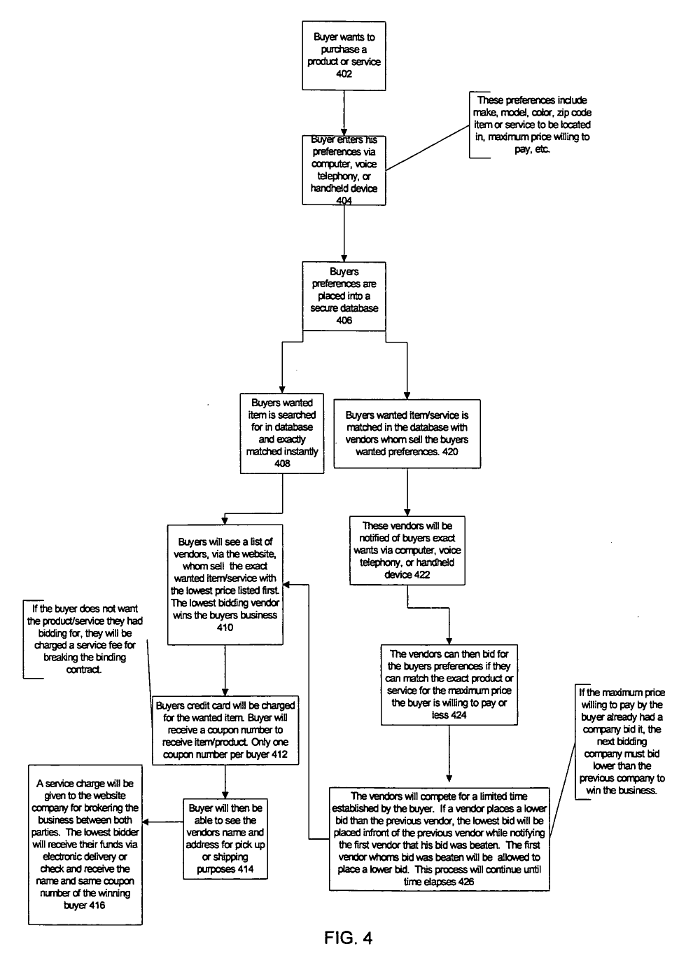

FIG. 4 shows another embodiment of a reverse auction system. A buyer wants to purchase a product or service (402). The buyer enters his preferences via computer, voice telephony, or handheld device (404). These preferences include make, model, color, zip code item or service to be located in, maximum price willing to pay, for example. The buyer's preferences are placed into a secure database (406). The buyer's wanted item is searched for in database and exactly matched instantly (408). The buyers will see a list of vendors on the website that sell the wanted item or service listed in an order, for example with the lowest price listed first. The lowest bidding vendor wins the buyer's business (410). The buyer's credit card will be charged for the wanted item. The buyer will receive a coupon number to receive item/product and one coupon number is issued per buyer (412). If the buyer subsequently does not want the product/service, he/she will be charged a service fee for breaking the binding contract. The buyer will then be able to see the vendors name and address for pick up or shipping purposes (414). A service charge will be given to the website company for brokering the business between both parties. The lowest bidder will receive their funds via electronic delivery or check and receive the name and same coupon number of the winning buyer (416).

Alternatively, from 402, the buyer's wanted item/service is matched in the database with vendors whom sell the buyer's wanted preferences (420). These vendors will be notified of buyer's requirements via computer, voice telephony, or handheld device (422). The vendors can then bid for the buyers preferences if they can match the exact product or service for the maximum price the buyer is willing to pay or less (424). The vendors will compete for a limited time established by the buyer. If a vendor places a lower bid than the previous vendor, the lowest bid will be placed in front of the previous vendor while notifying the first vendor that his bid was beaten. The first vendor whose bid was beaten will be allowed to place a lower bid. This process will continue until the auction ends (426). If the maximum price that the buyer was willing to pay already had a company bid, the next bidding company must bid lower than the previous bidding company to win the business.

In one implementation, the timed buyer-driven reverse auction system inexpensively connects buyers of products and services to vendors locally (e.g., within a specified radius determined by the buyer) and globally through the use of computer terminals or voice telephony. The buyer constructs a detail description of the products (e.g., make, model numbers, color and pictures) or services wanted, including a maximum price willing to pay, and submits the information via the Internet or voice telephony to the appropriate area within the reverse auction system. The vendors listed only for selling those products or services locally or globally will be notified that a buyer has established a time completion for all vendors bidding. The vendor will be notified of the entire buyer's terms (e.g., warranty, maximum price, shipping or pickup, etc.) while keeping anonymity. If the vendor accepts all the terms set forth by the buyer, they have the option to place a bid lower or equal to the maximum price set by the buyer or they can forgo the auction. The vendor must summit the same terms as the buyer and may supply descriptive analyses of the product to the buyer (i.e., make, model, color and even a picture). If the buyer sets the maximum price willing to pay too low for vendors, then no vendors will place bids on the products or services and time will elapse without bidding. If a vendor bids on a product or service, their bid will be placed into the reverse auction system for buyers and vendors to see. This will allow all appropriate vendors the ability to decide if they can sell a product or service cheaper than the first vendor. The system will decrease the next bid incrementally as new vendors place a bid. If so, the lowest bid will be placed on the Web site in front of the first bid while notifying the first vendor of the changes. If the original vendor can go lower than the second vendor, the first vendor may modify their bid lower to beat out other vendors. This will continue until the end time is reached in which the lowest bidding vendor is bound to a legal contract with the buyer.

The above embodiments allow the buyer to purchase products and services from a vendor within a specified geographical area and provide a true buyer-driven system that allows buyers to qualify themselves to vendors and allows vendors to efficiently find qualified buyers. For example, a buyer receives bidding from vendors to receive a haircut in a specified area. Only qualified vendors within the system would receive the customer and be rewarded by the monetary charge for the service. The unqualified vendor would not bid for this service; they would loss money when they provided no haircut service to the buyer while incurring fees for using the system. This is what makes this system more qualified than the traditional buyer-driven systems.

An environment for processing a computerized reverse auction transaction is discussed next. A server is connected to a network such as the Internet. One or more client workstations are also connected to the network. The client workstations can be personal computers or workstations running browsers such as Netscape or Internet Explorer. With the browser, a client or user can access the server's Web site by clicking in the browser's Address box, and typing the address (for example, www.reverse-auction.com), then press Enter. When the page has finished loading, the status bar at the bottom of the window is updated. The browser also provides various buttons that allow the client or user to traverse the Internet or to perform other browsing functions.

An Internet community with one or more companies, service providers, manufacturers, or marketers is connected to the network and can communicate directly with users of the client workstations or indirectly through the server. The Internet community can provide the client workstations with access to a network of trading specialists and facilitators. Additionally, the Internet community also provides access to a variety of supporting members such as service firms and other service providers, such as printers or archival firms, among others.

Although the server can be an individual server, the server can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server can also be protected by a firewall. When the firewall receives a network packet from the network, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server. If both the source and destination are firewalls, the only addresses visible (i.e., unencrypted) on the network are those of the firewall. The addresses of computers on the internal networks, and, hence, the internal network topology, are hidden. This is called “virtual private networking” (VPN). The server supports a real estate transaction portal that provides a single point of integration, access, and navigation through the multiple enterprise systems and information sources facing knowledge users operating the client workstations. The portal can additionally support services that are transaction driven. Once such service is advertising: each time the user accesses the portal, the client workstation downloads information from the server. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Other services can be supported as well. For example, a user can rent space on the server to enable him/her to download application software (applets) and/or data—anytime and anywhere. By off-loading the storage on the server, the user minimizes the memory required on the client workstation 404-406, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee.

It is to be understood that the invention can be carried out by specifically different equipment and devices, and that various modifications, both as to the equipment details and operating procedures, can be accomplished without departing from the scope of the invention itself.

What is claimed is:

1. A computer-implemented method for conducting a reverse auction, comprising:
receiving request data from a buyer for a requested item, the request data including an item description and bid evaluation information including at least desired price and proximity to a predetermined location;
storing the request data in a requisition database;
receiving bid data generated in response to the request data, the bid data including bid item information generated in response to the item description of the requested item and bid evaluation information;
storing the bid data in a bid database; and,
determining at least one winning bid at auction close based the bid data matching desired price and proximity.

2. The method of claim 1, comprising receiving request data using one of: voice, voice telephony, handheld data entry and computer.

3. The method of claim 1, wherein the preferences include one of: make, model, color, zip code item or service to be located in, maximum price willing to pay.

4. The method of claim 1, wherein the preferences are placed into a secure database.

5. The method of claim 1, wherein the requested item is searched in the database.

6. The method of claim 1, wherein a lowest bidding vendor wins the bid.

7. The method of claim 7, wherein the lowest bidding vendor receives a name and a coupon number.

8. The method of claim 1, wherein a buyer receives a coupon number to receive the requested item.

9. The method of claim 8, wherein the buyer is charged a service fee for rejecting the winning bid.

10. The method of claim 1, comprising matching the requested item in the database with vendors.

11. The method of claim 10, wherein the vendors are notified through voice telephony

12. The method of claim 10, wherein the vendors are notified through a handheld device.

13. The method of claim 1, wherein the vendors compete for a predetermined time established by the buyer.

14. The method of claim 1, wherein a new lowest bid is received, comprising notifying the previous lowest bid vendor of the new lowest bid.

15. A system for conducting a reverse auction, comprising:
means for receiving request data from a buyer for a requested item, the request data including an item description and bid evaluation information including at least desired price and proximity to a predetermined location;
means for storing the request data in a requisition database;
receiving bid data generated in response to the request data, the bid data including bid item information generated in response to the item description of the requested item and bid evaluation information;
means for storing the bid data in a bid database; and,
means for determining at least one winning bid at auction close based the bid data matching desired price and proximity.

16. The system of claim 15, wherein the request data is received through one of: voice, voice telephony, handheld data entry and computer.

17. The system of claim 15, wherein the preferences include one of: make, model, color, zip code item or service to be located in, maximum price willing to pay.

18. The system of claim 15, wherein the preferences are placed into a secure database.

19. The system of claim 15, wherein the requested item is searched in the database.

20. The system of claim 15, wherein vendors compete for a predetermined time established by the buyer.
